(19) United States
(12) Patent Application Publication
(10) Pub. No.: US 2026/0301394 A1
(43) Pub. Date: Oct. 1, 2026

(54) IMAGE PROCESSING METHOD, APPARATUS, AND ELECTRONIC DEVICE

(71) Applicant: Lenovo (Beijing) Limited, Beijing (CN)

(72) Inventors: Bojie YU, Beijing (CN); Rui MA, Beijing (CN)

(21) Appl. No.: 19/574,864

(22) Filed: Mar. 23, 2026

(30) Foreign Application Priority Data
Mar. 26, 2025 (CN) 202510369353.7

(51) Int. Cl. G06V 10/80; G06V 10/60; G06V 10/77; G06V 10/82

(52) U.S. Cl. CPC G06V 10/806; G06V 10/60; G06V 10/7715; G06V 10/82

(57) ABSTRACT

An image processing method includes obtaining source images sent by data sources and having different image quality, performing decomposition operation on the source images through an intelligent model to form map sets each including illumination and reflectance maps, performing feature extraction on the map sets to generate feature data sets each including first and second feature data extracted from the illumination and reflectance maps, respectively, of a corresponding map set, performing adjustment on the first and/or second feature data of at least one feature data set based on an adjustment parameter that is a preset parameter or is determined based on at least one source image, generating fused feature maps each being generated by fusing the first and second feature data of a corresponding data set through the intelligent model, and constructing target images based on the fused feature maps, respectively.

### CROSS-REFERENCE TO RELATED APPLICATION

This application claims priority to Chinese Patent Application No. 202510369353.7, filed on Mar. 26, 2025, the entire content of which is incorporated herein by reference.

### TECHNICAL FIELD

The present disclosure generally relates to the field of image processing and, more particularly, to an image processing method and apparatus, and an electronic device.

### BACKGROUND

In various processing scenarios, the video data captured by multiple data streams may differ in quality and parameters. Therefore, maintaining consistent quality across multiple video sources when displaying multiple video sources to the user cannot be guaranteed. For example, in live streaming scenarios involving multiple locations, the quality and parameters of different video sources may vary. Improper handling can lead to unstable output quality and a poor viewing experience for the user.

### SUMMARY

In accordance with the disclosure, there is provided an image processing method including obtaining a plurality of source images sent by at least two data sources and having different image quality, performing decomposition operation on the plurality of source images through an intelligent model to form a plurality of map sets each including an illumination map and a reflectance map, performing feature extraction on the plurality of map sets to generate a plurality of feature data sets each including first feature data and second feature data extracted from the illumination map and the reflectance map, respectively, of a corresponding one of the plurality of map sets, performing adjustment on at least one of the first feature data or the second feature data of at least one of the plurality of feature data sets based on an adjustment parameter that is a preset parameter or is determined based on at least one of the plurality of source images, generating a plurality of fused feature maps each being generated by fusing the first feature data and the second feature data of a corresponding one of the plurality of feature data sets through the intelligent model, and constructing a plurality of target images based on the plurality of fused feature maps, respectively.

Also in accordance with the disclosure, there is provided an electronic device including a processor, and a memory storing an application program that, when executed by the processor, causes the electronic device to obtain a plurality of source images sent by at least two data sources and having different image quality, perform decomposition operation on the plurality of source images through an intelligent model to form a plurality of map sets each including an illumination map and a reflectance map, perform feature extraction on the plurality of map sets to generate a plurality of feature data sets each including first feature data and second feature data extracted from the illumination map and the reflectance map, respectively, of a corresponding one of the plurality of map sets, perform adjustment on at least one of the first feature data or the second feature data of at least one of the plurality of feature data sets based on an adjustment parameter that is a preset parameter or is determined based on at least one of the plurality of source images, generate a plurality of fused feature maps each being generated by fusing the first feature data and the second feature data of a corresponding one of the plurality of feature data sets through the intelligent model, and construct a plurality of target images based on the plurality of fused feature maps, respectively.

Also in accordance with the disclosure, there is provided a non-transitory computer-readable storage medium storing an application program that, when executed by a processor, cause an electronic device including the processor to obtain a plurality of source images sent by at least two data sources and having different image quality, perform decomposition operation on the plurality of source images through an intelligent model to form a plurality of map sets each including an illumination map and a reflectance map, perform feature extraction on the plurality of map sets to generate a plurality of feature data sets each including first feature data and second feature data extracted from the illumination map and the reflectance map, respectively, of a corresponding one of the plurality of map sets, perform adjustment on at least one of the first feature data or the second feature data of at least one of the plurality of feature data sets based on an adjustment parameter that is a preset parameter or is determined based on at least one of the plurality of source images, generate a plurality of fused feature maps each being generated by fusing the first feature data and the second feature data of a corresponding one of the plurality of feature data sets through the intelligent model, and construct a plurality of target images based on the plurality of fused feature maps, respectively.

### BRIEF DESCRIPTION OF THE DRAWINGS

FIG. 1 is a flowchart of an image processing method consistent with the present disclosure.

FIG. 2 is a flowchart of an embodiment of S400 in FIG. 1 consistent with the present disclosure.

FIG. 3 is a flowchart of a first embodiment of an image processing method consistent with the present disclosure.

FIG. 4 is a flowchart of a second embodiment of an image processing method consistent with the present disclosure.

FIG. 5 is a flowchart of a third embodiment of an image processing method consistent with the present disclosure.

FIG. 6 schematically shows an internal connection relationship of an electronic device consistent with the present disclosure.

FIG. 7 is a structural diagram of an electronic device consistent with the present disclosure.

### DETAILED DESCRIPTION OF THE EMBODIMENTS

Various aspects and features of the present disclosure are described herein with reference to the accompanying drawings.

It should be understood that various modifications can be made to the embodiments of the present disclosure. Therefore, the foregoing description should not be considered limiting, but merely as examples of embodiments. Other modifications within the scope and spirit of the present disclosure will be apparent to those skilled in the art.

The accompanying drawings, which are included in and constitute a part of this specification, illustrate embodiments of the present disclosure and, together with the general description of the present disclosure given above and the detailed description of the embodiments given below, serve to explain the principles of the present disclosure.

These and other features of the present disclosure will become apparent from the following description of embodiments given as non-limiting examples with reference to the accompanying drawings.

It should also be understood that although the present disclosure has been described with reference to some specific examples, many other equivalent forms of the present disclosure can be implemented by those skilled in the art.

The above and other aspects, features, and advantages of the present disclosure will become more apparent when taken in conjunction with the accompanying drawings, in light of the following detailed description.

Specific embodiments of the present disclosure are subsequently described with reference to the accompanying drawings. However, it should be understood that the claimed embodiments are merely examples of the present disclosure, which can be implemented in various ways. Well-known and/or repetitive functions and structures are not described in detail to avoid unnecessary or redundant details that could obscure the present disclosure. Therefore, the specific structural and functional details claimed herein are not intended to be limiting, but merely serve as a basis and representative basis for teaching those skilled in the art to use the present disclosure in various ways with substantially any suitable detailed structure.

This specification may use the phrases “in one embodiment,” “in another embodiment,” “in yet another embodiment,” or “in other embodiments,” all of which may refer to one or more of the same or different embodiments according to the present disclosure.

An image processing method consistent with the embodiments of the present disclosure processes source images sent from at least two data sources using an intelligent model, enabling the processed images to have the same or similar quality, thereby maintaining stable image quality output after processing while switching between at least two source images.

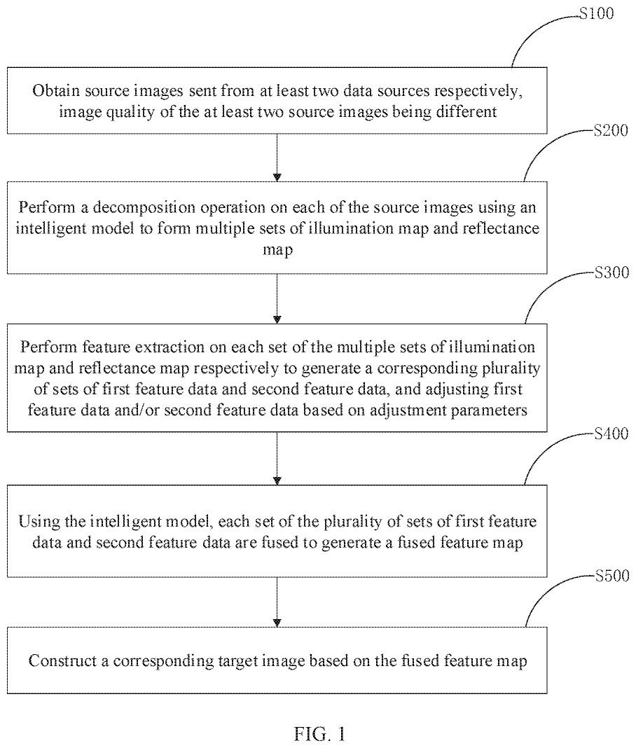

The image processing method of the present disclosure will be described in detail below with reference to specific embodiments. FIG. 1 is a flowchart of the image processing method consistent with the embodiments of the present disclosure. As shown in FIG. 1, the method includes the following.
S100, source images sent from at least two data sources respectively are obtained, the image quality of the at least two source images being different.

For example, the data source can be an image acquisition device used to obtain images of a target object, which is the object being photographed, such as object in various types of live broadcasts, monitored object, or production product object.

In some embodiments, at least two data sources can be data sources located at different shooting angles, data sources captured at different time periods, or data sources targeting different target objects. For example, in a live race or sports event broadcast, multiple data sources can be set up at different locations within the race venue to capture different source images.

In some embodiments, multiple data sources send their respective source images. Since the device performance, shooting conditions, and shooting time of each data source may differ, the image quality of the source images will vary. For example, the source image captured and sent to the electronic device by a first data source may have a first image quality, while the source image captured and sent to the electronic device by a second data source may have a second image quality. The first image quality is higher than the second image quality.

The electronic device obtains multiple source images from the multiple data sources. Each source image is then processed separately.
S200, a decomposition operation is performed on each of the source images using an intelligent model to form multiple sets of illumination map and reflectance map.

For example, the intelligent model can be a neural network model capable of processing images, such as a deep learning model, the intelligent model includes convolutional neural network (CNN) and augmentation network, or just the CNN. The CNN is a deep learning model designed to process data with a grid structure (such as images and audio), including convolutional layers, pooling layers, and fully connected layers. Convolutional layers perform convolution operations by sliding convolution kernels across the input data, extracting local features. The parameters in the convolutional kernels are shared, which greatly reduces the number of parameters in the model, lowering computational cost and the risk of overfitting. Pooling layers are typically used for downsampling, i.e., compressing the feature maps extracted by the convolutional layers. Common pooling methods include max pooling and average pooling, which can retain key features while reducing data dimensionality, improving model robustness and computational efficiency. Fully connected layers, after multiple convolutional and pooling layers, integrate the extracted features and map the extracted features to the output space through a fully connected manner for the final classification or regression task. Augmented networks can enrich training dataset of CNN by generating high-quality images, further improving performance of the CNN.

Consistent with the present disclosure, an intelligent model is used to decompose each source image. Each source image can be decomposed into a corresponding illumination map and reflectance map, thus forming multiple sets of illumination map and reflectance map (a set of illumination map and reflectance map is also referred to as a “map set”). One source image corresponds to one set of illumination map (illumination image) and reflectance map (reflectance image). An illumination map is an image that reflects the lighting conditions of an object or scene. Illumination map has distinct bright and dark areas. The direction, intensity, and color of light cause different lighting and shadow effects on the object's surface, a rich sense of depth and dimension. Reflection image is formed based on the principle of light reflection. When light shines on an object's surface, some light is absorbed, and some is reflected. The reflected light enters the human eye or imaging device, forming a reflectance map.

Consistent with the present disclosure, the intelligent model decomposes the source images based on the formation principles of illumination maps and reflectance maps. The illumination map of the source image depicts the bright and dark areas of the source image, as well as the direction, intensity, and color of the light. The reflectance map of the source image depicts the characteristics of light illumination and reflectance in the source image. The intelligent model decomposes each set of source images, forming multiple sets of illumination map and reflectance map. Each set of illumination map and reflectance map corresponds to one source image.
S300, feature extraction is performed on each set of the multiple sets of illumination map and reflectance map respectively to generate a corresponding plurality of sets of first feature data and second feature data (a set of first feature data and second feature data is also referred to as a “feature data set”); and the first feature data and/or the second feature data are adjusted based on one or more adjustment parameters. The one or more adjustment parameters are preset parameters or parameters determined based on at least one of the source images.

For example, the intelligent model performs feature extraction on each set of illumination map and reflectance map, including the following. In the same set, feature extraction is performed on the illumination map to generate corresponding first feature data, so that the first feature data can characterize the characteristics of the current illumination map; feature extraction is performed on the reflectance map to generate corresponding second feature data, so that the second feature data can characterize the characteristics of the current reflectance map. In another set, feature extraction is performed again on the illumination map to generate corresponding first feature data, and feature extraction is performed on the reflectance map to generate corresponding second feature data.

In some embodiments, feature extraction on a lighting image includes color feature extraction, texture feature extraction, edge feature extraction, and deep learning-based feature extraction. For example, on one hand, histogram statistics are performed on the red, green, and blue channels in the RGB color space of the lighting image to obtain three histograms, which are combined to describe the color features of the lighting image. On the other hand, a gray-level co-occurrence matrix (GLCM) is generated by calculating the frequency of occurrence of different gray-level pixel pairs in the lighting image. Multiple texture features, such as contrast, correlation, energy, and entropy, can be extracted from the GLCM.

Feature extraction on a reflectance map includes geometric feature extraction, texture feature extraction, color feature extraction, and deep learning-based feature extraction. For example, on one hand, the edges and contours of objects in a reflectance map are important geometric features. Edge detection algorithms, such as the Canny operator and the Sobel operator, can be used to extract the edges of objects in the reflectance map. By connecting these edge points, the contour of the object can be obtained. On the other hand, a GLCM is generated by calculating the frequency of occurrence of different gray-level pixel pairs in specific directions and distances. Features such as contrast, correlation, energy, and entropy can be extracted from the GLCM. These features reflect information such as the roughness and texture direction of the reflective surface.

One or more adjustment parameters are used to adjust the first feature data and/or the second feature data, ensuring that the fused image obtained by fusing the first feature data and the second feature data meets image quality requirements. On one hand, the one or more adjustment parameters are preset parameters, specifically set in advance based on historical or empirical data. The one or more adjustment parameters are then used when adjusting each set of first feature data and the second feature data. On the other hand, the one or more adjustment parameters are determined based on at least one source image. For example, the one or more adjustment parameters can be determined from one or more source images among multiple source images, such as the source image with the best image quality. Therefore, after the first feature data and the second feature data are adjusted using the one or more adjustment parameters, a target image with higher image quality than the original image from other source images can be obtained after processing. In this way, each image obtained by the electronic device from multiple data sources can meet the image quality requirements, and the image quality of each image can remain consistent. For example, during live streaming, when switching between multiple data sources at the live streaming location, the image quality of each target image obtained can remain consistent.
S400, using the intelligent model, each set of the plurality of sets of first feature data and second feature data are fused to generate a fused feature map.

For example, fusing different types of feature data can fully utilize the advantages of each feature, improving the data representation ability and model performance. Consistent with the present disclosure, the intelligent model is used to fuse each set of the plurality of sets of first feature data and second feature data after parameter adjustments respectively to generate a corresponding fused feature map. The fused feature map can more fully represent the features of the corresponding source image. The specific fusion method can be implemented through various fusion techniques. For example, each data unit in the first feature data can be added, weighted, concatenated, and/or multiplied with the corresponding data unit in the second feature data to obtain a fused data unit, which is then used to obtain the fused feature map.

In some embodiments, since the image quality of each source image is different, the image quality corresponding to the fused feature map obtained by fusing each set of the plurality of sets of first feature data and second feature data is also different.
S500, the corresponding target image is constructed based on the fused feature map.

For example, when reconstructing an image based on a fused feature map, a generator in an intelligent model can use the fused feature map as input. By continuously adjusting parameters, the generated image is made as close as possible to the real image. Simultaneously, a discriminator evaluates the generated image and provides feedback to the generator to optimize the generation process. The fused feature map can be normalized to ensure the values of the fused feature map fall within a specific range. Feature adjustment can also be performed on the fused feature map, such as adding additional layers to further extract or transform features, or cropping and stitching the fused feature map. A decoder can then be used to decode the features to reconstruct the image, thereby obtaining the target image.

The image processing method in the present disclosure can extract features from each source image obtained from multiple data sources and adjust the features based on one or more adjustment parameters, ensuring consistent image quality for each target image, maintaining stable image quality while switching between target images from multiple data sources, and improving the user experience.

In some embodiments, the intelligent model includes a CNN. Decomposing each source image using the intelligent model to form multiple sets of illumination map and reflectance map includes inputting the source images into the CNN, so that the CNN outputs corresponding illumination maps and reflectance maps based on learned features and a mapping relationship of source images with related images. The loss function of the CNN is determined based on the reflectivity consistency of the reflectance map and the smoothness of the illumination map.

For example, the intelligent model can first perform some preprocessing on the input source image, such as normalization and color space conversion, to reduce the impact of illumination and reflectance changes on the image. Then, the preprocessed source image is input into the CNN. The CNN learns the features of the image to establish a mapping relationship from the input source image to the illumination map and reflectance map, thereby determining the illumination map and reflectance map based on this mapping relationship. The CNN can adopt an encoder-decoder architecture, where the encoder extracts high-level features of the image, and the decoder generates the illumination map and reflectance map based on these features. To better align with physical model, loss function is typically designed based on the physical characteristics of image, such as energy conservation and the range of reflectance values.

In some embodiments, the loss function of the CNN in this embodiment can be determined based on the reflectance consistency of the reflectance map and the smoothness of the illumination map. The loss function, as an evaluation metric in CNN, measures the difference or error between the output of the CNN and the true label. Therefore, minimizing the loss function can optimize the parameters of the intelligent model. The loss function can be a non-negative real number function, denoted as L(Y, f(X)), where Y is the actual value (also called the label or true value), f(X) is the model's predicted value (also called the output value or estimate value), and X is the input data. The smaller the value of the loss function, the closer the model's prediction is to the actual value, and the better the performance of the intelligent model. Consistent with the present disclosure, the loss function is determined based on the reflectance consistency of the reflectance map and the smoothness of the illumination map, enabling the CNN to maintain the smoothness of the illumination map within a corresponding range while simultaneously maintaining the reflectance consistency within a corresponding range during image processing.

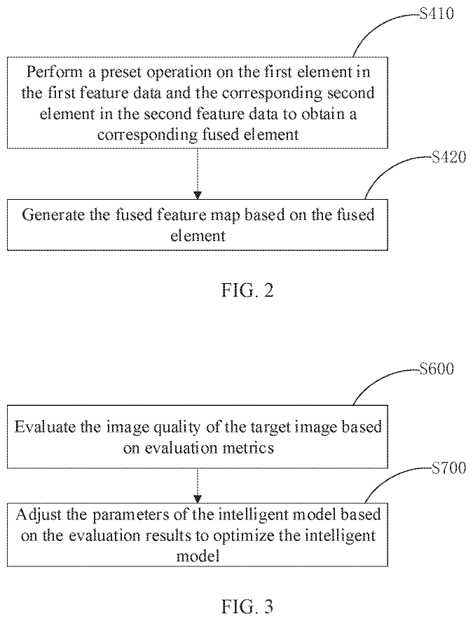

In some embodiments, fusing each set of the plurality of sets of first feature data and second feature data respectively to generate a fused feature map using the intelligent model, as shown in FIG. 2, includes the following.
S410, a preset operation is performed on the first element in the first feature data and the corresponding second element in the second feature data to obtain a corresponding fused element. The preset operation includes at least one of an addition operation, a weighted operation, a concatenation operation, and a multiplication operation.
S420, the fused feature map is generated based on the fused element.

For example, in the process of image fusion, preset operation can be performed on corresponding elements of two feature maps with the same shape in the first feature data and the second feature data to obtain corresponding fused elements.

When the preset operation is addition, the corresponding feature values from different feature sources (first feature data and second feature data) are directly added together. For example, the feature vector A=(a1, a2, . . . , an) in the first feature data and B=(b1, b2, . . . , bn) in the second feature data are added together to obtain the fused feature vector (fused element) F=(a1+b1, a2+b2, . . . , an+bn). The addition operation can preserve information from each feature to a certain extent. When different features are complementary and contribute similarly to the result, the addition operation can effectively combine these features.

When the preset operation is a weighted operation, corresponding weights are assigned to features from different feature sources, and then the weighted feature values are added together. Given feature vectors A=(a1, a2, . . . , an) and B=(b1, b2, . . . , bn), and the corresponding weight vector W=(w1, w2, . . . , wn), the fused feature vector F=(w1a1+w1b1, w2a2+w2b2, . . . , wnan+wnbn). The magnitude of the weights reflects the importance of the corresponding features and can be obtained through learned training data or set based on prior knowledge. The weighted operation can weight features according to the importance of features, thus more flexibly fusing different features. The weighted operation can effectively highlight features that have a greater impact on the result, suppress unimportant features, and improve the quality and representativeness of the fused features.

When the preset operation is concatenation, feature vectors of different feature sources are joined in a specific order to form a longer feature vector. For example, given feature vectors A=(a1, a2, . . . , am) and B=(b1, b2, . . . , bn), the concatenated fused feature vector F=(a1, a2, . . . , am, b1, b2, . . . , bn). Concatenation preserves all information from the original features without losing any details.

When the preset operation is multiplication, corresponding feature values from different feature sources are multiplied together. For feature vectors A=(a1, a2, . . . , an) and B=(b1, b2, . . . , bn), the fused feature vector F=(a1×b1, a2×b2, . . . , anxbn). Multiplication is often used to emphasize some interaction or correlation between features. When two features have large values in certain dimensions, multiplication makes the feature values in these dimensions more prominent, thereby highlighting the synergistic effect between features and discovering potential relationships between different features.

After each fused element is obtained, the fusion feature vector F as described above is used to combine the fused elements to form a fusion feature map.

In some embodiments, adjusting the first feature data and/or the second feature data based on the one or more adjustment parameters includes adjusting the first feature data and/or the second feature data corresponding to all the source images based on the one or more adjustment parameters, or, adjusting the first feature data and/or the second feature data corresponding to the source images that do not meet the first image quality requirement based on the one or more adjustment parameters. The one or more adjustment parameters include at least one of the following: brightness parameter, chromaticity parameter, and encoding parameter.

For example, the one or more adjustment parameters can be preset parameters, specifically preset based on historical data or empirical data, or based on parameters determined from at least one source image. On one hand, the one or more adjustment parameters can be used to adjust the first feature data and/or the second feature data corresponding to each source image, such as adjusting the target image by adjusting the brightness parameter, chromaticity parameter, and/or encoding parameter related to the first feature data and/or the second feature data, thereby improving the image quality of the target image corresponding to each source image, ensuring that the image quality of each target image meets the preset first image quality requirement.

On the other hand, among the various source images, some source images may meet the first image quality requirement, while others may not. To improve adjustment efficiency, only the first feature data and/or second feature data corresponding to the source images that do not meet the first image quality requirement can be adjusted, thus adjusting only the target images corresponding to a portion of the source images. This ensures that the target images corresponding to each data source meet the first image quality requirement. Therefore, the image quality of the current target image can be kept stable when switching between multiple target images.

In some embodiments, after the corresponding target image is constructed based on the adjusted fused feature map, as shown in FIG. 3, the method further includes the following.
S600, the image quality of the target image is evaluated based on evaluation metrics.
S700, the parameters of the intelligent model are adjusted based on the evaluation results to optimize the intelligent model.

For example, after a target image is constructed based on the intelligent model, the quality of the target image may meet user requirements or may contain errors. Consistent with the present disclosure, the image quality of the target image is evaluated based on evaluation metrics to determine whether the generated target image meets preset requirements. If the generated target image meets the preset requirements, indicating that the parameter configuration of the current intelligent model is appropriate. If the generated target image does not meet the preset requirements, indicating that the parameters of the current intelligent model need to be adjusted. Therefore, the parameters of the intelligent model can be adjusted correspondingly based on the evaluation results to optimize the intelligent model.

In some embodiments, the method further includes the following.

Determining a training dataset based on illumination map training data and reflectance map training data.

Based on the training dataset, a feature extraction strategy and a fusion strategy of the intelligent model are trained.

For example, the intelligent model needs to be trained to optimize itself, including data preparation, network construction, selection of appropriate loss function and optimizer, model training, and evaluation. A training dataset is prepared in advance for training the intelligent model. The training dataset is determined based on illumination map training data and reflectance map training data. The illumination map training data is used for the intelligent model to learn to decompose a source image into an illumination map, and the reflectance map training data is used for the intelligent model to learn to decompose a source image into a reflectance map. Both the illumination map training data and the reflectance map training data can be historical data used by the intelligent model or determined based on relevant empirical data.

After the intelligent model is trained based on the training dataset, the model can improve the intelligence and accuracy of the feature extraction strategy and the fusion strategy. The feature extraction strategy is used to extract features from the illumination map and reflectance map, while the fusion strategy is used to fuse the first feature data and the second feature data.

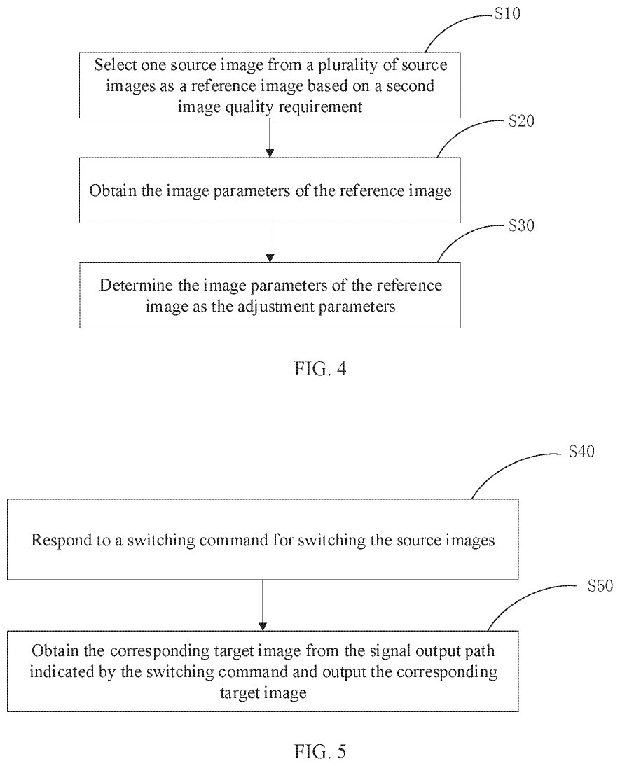

In some embodiments, as shown in FIG. 4, the method further includes the following.

Training the intelligent model using the training dataset allows the intelligent model to improve the intelligence of the feature extraction strategy and the fusion strategy. The method includes the following.
S10, one source image from a plurality of source images is selected as a reference image based on a second image quality requirement.

For example, the image quality of the plurality of source images is different, and some source images have relatively high image quality, meeting the second image quality requirement. Therefore, one of the source images that meets the second image quality requirement can be selected as the reference image. The reference image serves as a reference for adjusting other source images. The second image quality requirement can be a predetermined image quality requirement, such as determining the second image quality requirement based on the source image with the highest image quality among all source images, or, select one from multiple preset image quality requirements as the second image quality requirement.
S20, the image parameters of the reference image are obtained.

For example, the reference image includes corresponding image parameters, such as brightness parameters, color parameters, encoding parameters, resolution parameters, data volume parameters, etc. These image parameters can be obtained through analysis of the reference image itself.
S30, the image parameters of the reference image are determined as the one or more adjustment parameters.

For example, the one or more adjustment parameters are used to adjust the first feature data and/or the second feature data, thereby ensuring that the fused image obtained by fusing the first feature data and the second feature data meets the image quality requirements. After the image parameters of the reference image are determined as the one or more adjustment parameters, when using the one or more adjustment parameters to adjust the feature data corresponding to other source images, the reference image can be used as a reference, to improve the quality of the fused image corresponding to other source images, thereby improving the image quality of the target image corresponding to each source image.

In some embodiments, as shown in FIG. 5, the method further includes the following.
S40, a switching command for switching the source images is responded to.

For example, when an electronic device plays images from multiple data sources, the electronic device needs to switch between multiple images, such as switching images captured by cameras located at multiple different positions during a live racing broadcast. The user can actively operate or send a switching command to the electronic device (also a live streaming device) through other devices. The electronic device responds to the switching command and initiates a switching operation on multiple source images.
S50, the corresponding target image is obtained from the signal output path indicated by the switching command and output.

For example, the switching command can indicate the target image currently needed and the target image to be replaced. Each target image includes a corresponding data source and a related signal output path. For instance, a first data source includes a first signal output path, through the first signal output path the source image can be output to the electronic device, and a second data source includes a second signal output path, through the second signal output path the source image can be output to the electronic device, and so on. Therefore, the signal output path indicated by the switching command obtains the corresponding target image that the user currently needs to view, and thus the target image can be output for viewing. Of course, if the signal output path indicated by the updated switching command changes, the corresponding target image can be obtained from the signal output path indicated by the updated switching command and output, thereby realizing the switching operation of the target image.

The following describes in detail, with reference to a specific embodiment, the process by which the electronic device obtains and processes multiple source images based on internal functional modules of the electronic device.

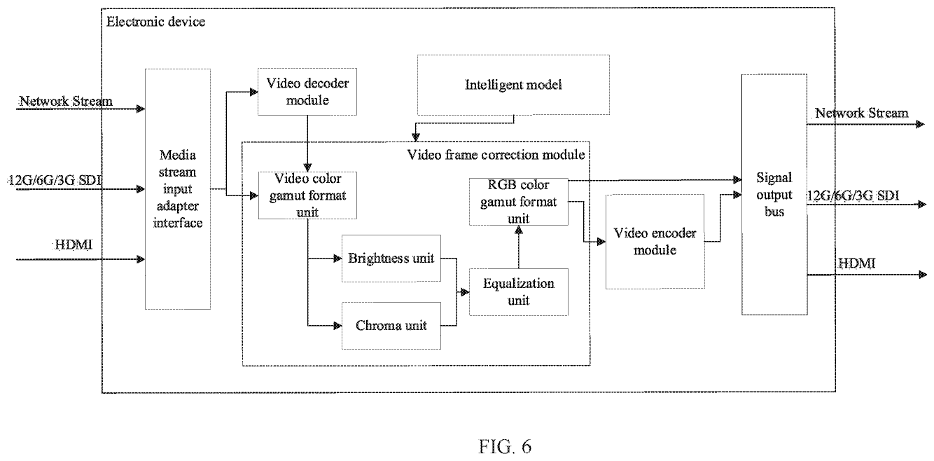

As shown in FIG. 6, the electronic device includes a media stream input adapter interface (Signal Adapter Switcher) that can connect to a network stream, a serial digital video interface (12G/6G/3G SDI), and a high-definition multimedia interface (High Definition Multimedia Interface), respectively, and obtain source images sent from these interfaces. The video decoder module in the electronic device performs video decoding processing on the source images and inputs the processed source images into the video frame correction module. The video frame correction module includes a video color gamut format unit (YUV/RGB), a brightness unit, a chroma unit, an equalization unit, and an RGB color gamut format unit. The video color gamut format unit performs color gamut processing on the image data, the brightness unit performs brightness processing on the image data, the chroma unit performs chroma processing on the image data, and the equalization unit adjusts the parameter equalization of the image data. An intelligent model connects to the video frame correction module and can control the video frame correction module to process the source images. The video frame correction module connects to the video encoder module. The video frame correction module compresses and encodes the corrected/repaired video frames and inputs the processed video frame into the signal output bus. The signal output bus compatible with streaming media, SDI signals, and HDMI interfaces, thereby outputting target images through each interface.

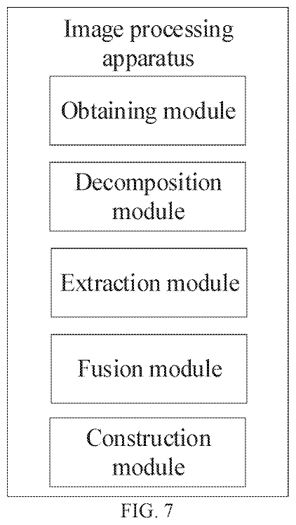

The present disclosure also provides an image processing apparatus, applicable to the electronic device, as shown in FIG. 7, including an obtaining module configured to obtain source images sent by at least two data sources, the image quality of the at least two of the source images being different.

For example, the data source can be an image acquisition device used to obtain images of a target object, and the target object is the object being photographed, such as object in various types of live broadcasts, monitored object, production product object, etc.

In some embodiments, the at least two data sources can be data sources at different shooting angles, data sources that are photographed at different time periods, or data sources targeting different target objects. For example, in a live racing broadcast or sports event broadcast, multiple data sources can be set at different locations at the racing venue to capture different source images.

In some embodiments, multiple data sources send their respective source images. Since the device performance, shooting conditions, and shooting time of each data source may differ, the image quality of the source images will vary. For example, the source image captured and sent to the electronic device by the first data source may have a first image quality, while the source image captured and sent to the electronic device by the second data source may have a second image quality. The first image quality is higher than the second image quality.

The obtaining module obtains multiple source images from the multiple data sources, allowing the electronic device to process each source image separately.

The decomposition module is configured to perform a decomposition operation on each of the source images using an intelligent model, forming multiple sets of illumination map and reflectance map.

For example, the intelligent model can be a neural network model capable of image processing, such as a deep learning model. The intelligent model includes a CNN and an augmentation network, or just the CNN. A CNN is a neural network that can process images. CNN is a deep learning model designed to process grid-structured data (such as images and audio). CNN includes convolutional layers, pooling layers, and fully connected layers. Convolutional layers extract local features by sliding convolution kernels across the input data. The parameters in the convolution kernels are shared, significantly reducing the number of parameters in the model and lowering computational cost and the risk of overfitting. Pooling layers are typically used for downsampling, compressing the feature maps extracted by the convolutional layers. Common pooling methods include max pooling and average pooling, which can retain key features while reducing data dimensionality, improving model robustness and computational efficiency. Fully connected layers integrate the extracted features, after multiple convolutional and pooling layers, and map the features to the output space for final classification or regression tasks. Augmentation networks can enrich the CNN training dataset by generating high-quality images, further improving performance of the CNN.

Consistent with the present disclosure, the decomposition module utilizes an intelligent model to decompose each source image separately. Each source image can be decomposed into a corresponding illumination map and reflectance map, forming multiple sets of illumination map and reflectance map, where each source image corresponds to a set of illumination map and reflectance map. An illumination map reflects the lighting conditions of an object or scene. Illumination map has distinct bright and dark areas. The direction, intensity, and color of light cause different lighting and shadow effects on the object's surface, creating rich layers and a sense of depth. Reflection image is formed based on the principle of light reflection. When light shines on an object's surface, some light is absorbed, and some light is reflected. The reflected light enters the human eye or imaging device, forming a reflectance map.

Consistent with the present disclosure, the decomposition module can use an intelligent model to decompose the source image based on the formation principles of illumination map and reflectance map. The resulting illumination map of the source image depicts the bright and dark areas, as well as the direction, intensity, and color of the light. The resulting reflectance map of the source image depicts the characteristics of light illumination and reflection. The intelligent model decomposes each set of source images, forming multiple sets of illumination map and reflectance map. Each set of illumination map and reflectance map corresponds to one source image.

The extraction module is used for extracting features from the illumination map and reflectance map of each set, generating corresponding first feature data and second feature data, and adjusting the first feature data and/or the second feature data based on one or more adjustment parameters, the one or more adjustment parameters being preset parameters or parameters determined based on at least one of the source images.

For example, the extraction module performs feature extraction on each set of illumination map and reflectance map, specifically in the following way. In the same set, the extraction module uses an intelligent model to extract features from the illumination map to generate corresponding first feature data, thereby enabling the first feature data to characterize the features of the current illumination map; and extract features from the reflectance map to generate corresponding second feature data, thereby enabling the second feature data to characterize the features of the current reflectance map. In another set, the extraction module again uses an intelligent model to extract features from the illumination map to generate corresponding first feature data, and extract features from the reflectance map to generate corresponding second feature data.

In some embodiments, feature extraction from the illumination map includes color feature extraction, texture feature extraction, edge feature extraction, and deep learning-based feature extraction. For example, on one hand, histogram statistics are performed on the red, green, and blue channels in the RGB color space of the illumination map, resulting in three histograms that can be combined to describe the color characteristics of the illumination map. On the other hand, by calculating the frequency of occurrence of different gray-level pixel pairs in the illumination map, a gray-level co-occurrence matrix (GLCM) is generated. Multiple texture features, such as contrast, correlation, energy, and entropy, can be extracted from the GLCM.

Feature extraction from reflectance maps includes geometric feature extraction, texture feature extraction, color feature extraction, and deep learning-based feature extraction. For example, on one hand, the edges and contours of objects in a reflectance map are important geometric features. Edge detection algorithms, such as the Canny operator and the Sobel operator, can be used to extract the edges of objects in the reflectance map. By connecting these edge points, the contour of the object can be obtained. On the other hand, by calculating the frequency of occurrence of different gray-level pixel pairs at specific directions and distances, a GLCM is generated. Features such as contrast, correlation, energy, and entropy can be extracted from the GLCM, reflecting information such as the roughness and texture direction of the reflective surface.

One or more adjustment parameters are used to adjust the first feature data and/or the second feature data, thereby ensuring that the fused image obtained by fusing the first feature data and the second feature data meets image quality requirements. On one hand, the one or more adjustment parameters are preset parameters, specifically set in advance based on historical or empirical data, so that the one or more adjustment parameters are used when adjusting each set of first feature data and the second feature data. On the other hand, the one or more adjustment parameters are determined based on at least one source image, such as one or more source images from multiple source images, for example, based on the source image with the best image quality. Therefore, after the first feature data and the second feature data are adjusted using the one or more adjustment parameters, a target image with higher image quality than the original image from other source images can be obtained after processing. In this way, each image obtained by the electronic device from multiple data sources can meet the image quality requirements, and the image quality of each image can remain consistent. For example, during live streaming, when switching between multiple data sources at the live streaming location, the image quality of each target image obtained can remain consistent.

The fusion module is configured to fuse each set of the plurality of sets of first feature data and second feature data using the intelligent model to generate a fused feature map.

For example, fusing different types of feature data can fully utilize the advantages of each feature, improving the data's representational ability and the model's performance. Consistent with the present disclosure, an intelligent model is used to fuse each set of the plurality of sets of first feature data and second feature data after parameter adjustments respectively, generating a corresponding fused feature map. This fused feature map can more fully represent the features of the corresponding source image. The specific fusion method can be implemented through various fusion techniques. For example, the fusion module can perform addition, weighted operation, concatenation, and/or multiplication operation on each data unit in the first feature data and the corresponding data unit in the second feature data to obtain fused data units, which are then used to obtain the fused feature map.

In some embodiments, since the image quality of each source image is different, the image quality corresponding to the fused feature map obtained by the fusion module from fusing each set of the plurality of sets of first feature data and second feature data is also different.

A construction module is configured to construct a corresponding target image based on the fused feature map.

For example, when reconstructing an image based on the fused feature map, the construction module can use the generator in the intelligent model using the fused feature map as input as input. By continuously adjusting the parameters, the generated image is made as close as possible to the real image. Simultaneously, the discriminator evaluates the generated image and feeds feedback to the generator to optimize the generation process. The fused feature map can be normalized to ensure the values of the fused feature map are within a specific range. Feature adjustments can also be made to the fused feature map, such as adding additional layers to further extract or transform features, or performing operations like cropping or stitching the fused feature map. The decoder can then be used to decode the features to reconstruct the image, thereby obtaining the target image.

In some embodiments, the decomposition module is further configured to input the source images into the CNN, so that the CNN outputs corresponding illumination maps and reflectance maps based on the learned features and a mapping relationship of source images with related images. The loss function of the CNN is determined based on the reflectivity consistency of the reflectance map and the smoothness of the illumination map.

In some embodiments, the fusion module is further configured to perform a preset operation on a first element in the first feature data and a second element in the corresponding second feature data to obtain a corresponding fused element, where the preset operation includes at least one of an addition operation, a weighted operation, a concatenation operation, and a multiplication operation, and, generate the fused feature map based on the fused element.

In some embodiments, the extraction module is further configured to adjust the first feature data and/or the second feature data corresponding to all the source images based on the one or more adjustment parameters, or, adjust the first feature data and/or the second feature data corresponding to source images that do not meet the first image quality requirement based on the one or more adjustment parameters, where the one or more adjustment parameters include at least one of the following: brightness parameter, chromaticity parameter, and encoding parameter.

In some embodiments, the image processing apparatus further includes an evaluation module, configured to evaluate the image quality of the target image based on evaluation metrics, and adjust the parameters of the intelligent model based on the evaluation results to optimize the intelligent model.

In some embodiments, the image processing apparatus further includes a training module, configured to determine a training dataset based on illumination map training data and reflectance map training data, and train the feature extraction strategy and fusion strategy of the intelligent model based on the training dataset.

In some embodiments, the extraction module is further configured to select one of the multiple source images as a reference image based on a second image quality requirement, obtain image parameters of the reference image, and determine the image parameters of the reference image as the one or more adjustment parameters.

In some embodiments, the image processing apparatus further includes a switching module, configured to respond to a switching instruction for switching the source images, obtain the corresponding target image from the signal output path indicated by the switching instruction, and output the corresponding target image.

The present disclosure also provides an electronic device, including a processor and a memory, where the memory stores an executable program, and the memory executes the executable program to perform the method described above.

The above embodiments are merely exemplary embodiments of the present disclosure and are not intended to limit the present disclosure. The scope of the present disclosure is defined by the claims. Those skilled in the art can make various modifications or equivalent substitutions to the present disclosure within the substance and scope of the present disclosure, and such modifications or equivalent substitutions should also be considered to fall within the scope of the present disclosure.

What is claimed is:

1. An image processing method comprising:
obtaining a plurality of source images sent by at least two data sources and having different image quality;
performing decomposition operation on the plurality of source images through an intelligent model to form a plurality of map sets each including an illumination map and a reflectance map;
performing feature extraction on the plurality of map sets to generate a plurality of feature data sets each including first feature data and second feature data extracted from the illumination map and the reflectance map, respectively, of a corresponding one of the plurality of map sets;
performing adjustment on at least one of the first feature data or the second feature data of at least one of the plurality of feature data sets based on an adjustment parameter, the adjustment parameter being a preset parameter or being determined based on at least one of the plurality of source images;
generating a plurality of fused feature maps, each being generated by fusing the first feature data and the second feature data of a corresponding one of the plurality of feature data sets through the intelligent model; and
constructing a plurality of target images based on the plurality of fused feature maps, respectively.

2. The method according to claim 1, wherein:
the intelligent model includes a convolutional neural network; and
performing the decomposition operation includes, for each of the plurality of source images:
inputting the source image into the convolutional neural network to enable the convolutional neural network to output the corresponding map set according to a learned feature and a mapping relationship between source images and related images, a loss function of the convolutional neural network being determined based on a reflectivity consistency of reflectance maps and a smoothness of illumination maps.

3. The method according to claim 1, wherein generating the plurality of fused feature maps includes, for each of the plurality of feature sets:
performing a preset operation on a first element in the first feature data and a second element in the second feature data corresponding to the first element to obtain a fused element, the preset operation including at least one of an addition operation, a weighted operation, a concatenation operation, or a multiplication operation; and
generating the fused feature map based on the fused element.

4. The method according to claim 1, wherein performing the adjustment includes, for each of the plurality of feature data sets:
adjusting at least one of the first feature data or the second feature data based on the adjustment parameter.

5. The method according to claim 1, wherein performing the adjustment includes:
determining, from the plurality of source images, one source image that does not meet an image quality requirement; and
adjusting at least one of the first feature data or the second feature data corresponding to the one source image based on the adjustment parameter, the adjustment parameter including at least one of a brightness parameter, a chroma parameter, or an encoding parameter.

6. The method according to claim 1, further comprising, after constructing the plurality of target images:
evaluating an image quality of at least one of the plurality of target images based on an evaluation metric; and
adjusting one or more parameters of the intelligent model based at least on the evaluation result to optimize the intelligent model.

7. The method according to claim 1, further comprising:
determining a training dataset based on illumination map training data and reflectance map training data; and
training a feature extraction policy and a fusion policy of the intelligent model based on the training dataset.

8. The method according to claim 1, further comprising:
selecting one of the plurality of source images as a reference image based on an image quality requirement;
obtaining an image parameter of the reference image; and
determining the image parameter of the reference image as the adjustment parameter.

9. The method according to claim 1, further comprising:
responding to a switching instruction for switching the plurality of source images; and
obtaining and outputting the corresponding target image from a signal output path indicated by the switching instruction.

10. An electronic device comprising:
a processor; and
a memory storing an application program that, when executed by the processor, causes the electronic device to:
obtain a plurality of source images sent by at least two data sources and having different image quality;
perform decomposition operation on the plurality of source images through an intelligent model to form a plurality of map sets each including an illumination map and a reflectance map;
perform feature extraction on the plurality of map sets to generate a plurality of feature data sets each including first feature data and second feature data extracted from the illumination map and the reflectance map, respectively, of a corresponding one of the plurality of map sets;
perform adjustment on at least one of the first feature data or the second feature data of at least one of the plurality of feature data sets based on an adjustment parameter, the adjustment parameter being a preset parameter or being determined based on at least one of the plurality of source images;
generate a plurality of fused feature maps, each being generated by fusing the first feature data and the second feature data of a corresponding one of the plurality of feature data sets through the intelligent model; and
construct a plurality of target images based on the plurality of fused feature maps, respectively.

11. The electronic device according to claim 10, wherein:
the intelligent model includes a convolutional neural network; and
the application program, when executed by the processor, further causes the electronic device to, when performing the decomposition operation, for each of the plurality of source images:
input the source image into the convolutional neural network to enable the convolutional neural network to output the corresponding map set according to a learned feature and a mapping relationship between source images and related images, a loss function of the convolutional neural network being determined based on a reflectivity consistency of reflectance maps and a smoothness of illumination maps.

12. The electronic device according to claim 10, wherein application program that, when executed by the processor, causes the electronic device to, when generating the plurality of fused feature maps includes, for each of the plurality of feature sets:
perform a preset operation on a first element in the first feature data and a second element in the second feature data corresponding to the first element to obtain a fused element, the preset operation including at least one of an addition operation, a weighted operation, a concatenation operation, or a multiplication operation; and
generate the fused feature map based on the fused element.

13. The electronic device according to claim 10, wherein application program that, when executed by the processor, causes the electronic device to, when performing the adjustment, for each of the plurality of feature data sets:
adjust at least one of the first feature data or the second feature data based on the adjustment parameter.

14. The electronic device according to claim 10, wherein application program that, when executed by the processor, causes the electronic device to, when performing the adjustment:
determine, from the plurality of source images, one source image that does not meet an image quality requirement; and
adjust at least one of the first feature data or the second feature data corresponding to the one source image based on the adjustment parameter, the adjustment parameter including at least one of a brightness parameter, a chroma parameter, or an encoding parameter.

15. The electronic device according to claim 10, wherein application program that, when executed by the processor, causes the electronic device to, after constructing the plurality of target images:
evaluate an image quality of at least one of the plurality of target images based on an evaluation metric; and
adjust one or more parameters of the intelligent model based at least on the evaluation result to optimize the intelligent model.

16. The electronic device according to claim 10, wherein application program that, when executed by the processor, causes the electronic device to:
determine a training dataset based on illumination map training data and reflectance map training data; and
train a feature extraction policy and a fusion policy of the intelligent model based on the training dataset.

17. The electronic device according to claim 10, wherein application program that, when executed by the processor, causes the electronic device to:
select one of the plurality of source images as a reference image based on an image quality requirement;
obtain an image parameter of the reference image; and
determine the image parameter of the reference image as the adjustment parameter.

18. The electronic device according to claim 10, wherein application program that, when executed by the processor, causes the electronic device to:
respond to a switching instruction for switching the plurality of source images; and
obtain and outputting the corresponding target image from a signal output path indicated by the switching instruction.

19. A non-transitory computer-readable storage medium storing an application program that, when executed by a processor, causes an electronic device including the processor to:
obtain a plurality of source images sent by at least two data sources and having different image quality;
perform decomposition operation on the plurality of source images through an intelligent model to form a plurality of map sets each including an illumination map and a reflectance map;
perform feature extraction on the plurality of map sets to generate a plurality of feature data sets each including first feature data and second feature data extracted from the illumination map and the reflectance map, respectively, of a corresponding one of the plurality of map sets;
perform adjustment on at least one of the first feature data or the second feature data of at least one of the plurality of feature data sets based on an adjustment parameter, the adjustment parameter being a preset parameter or being determined based on at least one of the plurality of source images;
generate a plurality of fused feature maps, each being generated by fusing the first feature data and the second feature data of a corresponding one of the plurality of feature data sets through the intelligent model; and
construct a plurality of target images based on the plurality of fused feature maps, respectively.

20. The non-transitory computer-readable storage medium according to claim 19, wherein:
the intelligent model includes a convolutional neural network; and
the application program, when executed by the processor, further causes the electronic device to, when performing the decomposition operation, for each of the plurality of source images:
input the source image into the convolutional neural network to enable the convolutional neural network to output the corresponding map set according to a learned feature and a mapping relationship between source images and related images, a loss function of the convolutional neural network being determined based on a reflectivity consistency of reflectance maps and a smoothness of illumination maps.
